(19) United States
(12) Patent Application Publication
(10) Pub. No.: US 2014/0373813 A1
(43) Pub. Date: Dec. 25, 2014

(54) VENTING A FUEL TANK BY MEANS OF A FUEL SUPPLY PATH AND AN AIR SUPPLY PATH OF AN INTERNAL COMBUSTION ENGINE

(71) Applicants: Georg Mallebrein, Korntal-Muenchingen (DE); Martin Klenk, Backnang (DE); Werner Haeming, Neudenau (DE); Marko Lorenz, Grossbottwar (DE); Hartmut Krueger, Buehl (DE); Timm Hollmann, Benningen A.N (DE); Dennis Glemser, Leinfelden-Echterdingen (DE); Stefan Gollnisch, Remseck (DE); Peter Schroepfer, Leinfelden-Echterdingen (DE); Martina Homeyer, Markgroeningen (DE); Franz Raichle, Korntal-Muenchingen (DE); Wolfgang Fischer, Gerlingen (DE); Andreas Pape, Oberriexingen (DE); Andreas Gutscher, Markgroeningen (DE); Juergen Schwarz, Schwieberdingen (DE); Thomas Keller, Rottweil (DE); Andreas Posselt, Muehlacker (DE); Georg Kurz, Son en Breugel (NL)

(72) Inventors: Georg Mallebrein, Korntal-Muenchingen (DE); Martin Klenk, Backnang (DE); Werner Haeming, Neudenau (DE); Marko Lorenz, Grossbottwar (DE); Hartmut Krueger, Buehl (DE); Timm Hollmann, Benningen A.N (DE); Dennis Glemser, Leinfelden-Echterdingen (DE); Stefan Gollnisch, Remseck (DE); Peter Schroepfer, Leinfelden-Echterdingen (DE); Martina Homeyer, Markgroeningen (DE); Franz Raichle, Korntal-Muenchingen (DE); Wolfgang Fischer, Gerlingen (DE); Andreas Pape, Oberriexingen (DE); Andreas Gutscher, Markgroeningen (DE); Juergen Schwarz, Schwieberdingen (DE); Thomas Keller, Rottweil (DE); Andreas Posselt, Muehlacker (DE); Georg Kurz, Son en Breugel (NL)

(73) Assignee: ROBERT BOSCH GMBH, Stuttgart (DE)

(21) Appl. No.: 14/352,720

(22) PCT Filed: Aug. 30, 2012
(86) PCT No.: PCT/EP2012/066816

§ 371 Date: Jul. 28, 2014

(30) Foreign Application Priority Data
Oct. 18, 2011 (DE) 10 2011 084 732.4

(51) Int. Cl. F02M 25/08; F02B 61/00

(52) U.S. Cl. CPC F02M 25/089; F02M 25/0872; F02M 25/0836; F02B 61/00
USPC 123/509; 123/519; 123/520; 123/495

(57) ABSTRACT

The invention relates to a system (1) for venting a fuel tank (3). The system (1) has a gas vessel (9), a first line (11), and a second line (13). The gas vessel (9) is designed to receive fuel vapor (7) from the fuel tank (3). The first line (11) connects the gas vessel (9) to an air supply path (21) of an internal combustion engine (19). The second line (13) connects the gas vessel (9) to a fuel supply path (30) of the internal combustion engine (19).

### BACKGROUND OF THE INVENTION

Exhaust gas reduction and monitoring are important concerns of modern sectors of industry. In the automotive industry, the escape of fuel vapors, for example, from the fuel tank to the environment has to be prevented. This takes place, for example, by means of an activated charcoal filter (ACF) which can readily absorb volatile hydrocarbons.

The activated charcoal filter can be regenerated by being flushed with fresh air, so that its absorbing capacity is preserved. The regeneration can take place, for example, by sucking fresh air from the environment through the charcoal filter. To this end, for example, a vacuum has to prevail in an engine air feed line, also called intake manifold, and a tank venting valve (TVV) has to be open. A vacuum in the engine air feed line can be generated as a rule merely in the case of an internal combustion engine which is running, with the result that a regeneration of the activated charcoal filter is not possible in the case of the engine being at a standstill. Furthermore, the vacuum and/or the number of vacuum phases in the engine air feed line, for example in the case of relatively small engines with turbocharging (downsizing), is no longer sufficient for the sufficient regeneration of the activated charcoal filter. The internal combustion engine is also inactive over relatively long time periods in the case of hybrid vehicles with an internal combustion engine as range extender or in the case of plug-in hybrids, with the result that a regeneration of the activated charcoal filter is not possible.

### SUMMARY OF THE INVENTION

There can therefore be a requirement for an improvement in the tank venting which is functional even in the case of a low pressure gradient between the activated charcoal filter or fresh air and the engine air feed line and prevents a positive pressure or vacuum in the fuel tank or overfilling of the activated charcoal filter even in the case of the internal combustion engine being at a standstill. This object can be achieved by the subject matter of the present invention.

In the following text, features, details and possible advantages of an apparatus according to embodiments of the invention will be described in detail.

According to a first aspect of the invention, a system is proposed for venting a fuel tank. The system has a gas container, a first line and a second line. The gas container is configured to receive fuel vapor from the fuel tank. The first line connects the gas container to an air supply path of an internal combustion engine. The second line connects the gas container to a fuel supply path of the internal combustion engine.

In other words, the concept of the present invention is based on connecting a tank venting system, in particular a gas container for receiving a mixture of air and fuel vapors, both to an air path and to a fuel path of an internal combustion engine.

As a result, the conventional tank venting can be relieved and at least part of the hydrocarbons which are emitted from the tank can be guided directly into the fuel path. Said second part can prevent overfilling of the activated charcoal filter even when a very large quantity of fuel is emitted from the tank and cannot be fed to the engine via the air path. Moreover, a certain redundancy results from the second path.

Furthermore, the functionalities of tank venting can be divided among the different feed lines to the internal combustion engine. For example, the fuel vapors can be condensed or liquefied in the second line in the case of an internal combustion engine which is running and can be fed to the internal combustion engine via the fuel supply path. The first line leads via a pressure holding valve into an activated charcoal filter. The pressure holding valve does not open until, for example, a defined pressure threshold value is exceeded in the gas volume or else a certain vacuum has built up in the tank and gas volume. When the internal combustion engine is at a standstill, the second line can be closed, with the result that the fuel vapors, for example in the case of the vehicle being switched off in the hot state, are fed to the air supply path and from there are stored, for example, in an activated charcoal filter. After restarting of the engine, the activated charcoal filter can be regenerated via the air supply path.

Air can also be sucked from the surroundings through a fresh air opening of an activated charcoal filter which is situated in the first line and pressure equalization can therefore be brought about for the case where a vacuum is produced in the fuel tank as a result of cooling in the case of a vehicle which is at a standstill. If, however, a pressure rise is produced in the gas container as a result of gas emissions from the tank, fuel vapor or condensate can be pumped from the gas container with the aid of a pump, which reduces the pressure in the gas space. The activation of the pump can be regulated with the aid of a pressure sensor which is attached in the gas space. Given sufficient pumping capacity, it can be prevented that the pressure holding valve opens and fuel vapors flow via the first line into the activated charcoal filter. If the pressure in the container undershoots a threshold, the pump can be stopped or turned down. As a result of the regenerating gases being pumped into the second line, the loading, and the regeneration which is necessary as a result, of an activated charcoal filter which is situated in the first line are reduced.

The system according to the invention can be used in motor vehicles having an internal combustion engine and, in particular, in hybrid vehicles having an internal combustion engine and an electric motor.

The gas container can be configured, for example, as part of the fuel tank, for example as a dome-like volume above the fuel tank or above the fuel surface in the case of a full tank. As an alternative, the gas container can be configured as a separate intermediate tank or gas space which is connected to the gas volume above the fuel level. Here, the gas container can be connected to the fuel tank in such a way that merely gases or vapors can pass from the fuel tank into the gas container. For example, a third line can branch off from the fuel tank above the fuel surface and can lead to the gas container. Here, the line can be configured, for example, in a labyrinthine or serpentine manner. Furthermore, a float can be provided in the fuel tank, which float closes the third line between the fuel tank and the gas container, for example, in the case of an inclination of the vehicle or the fuel tank.

The gas container can optionally have a cooling means, in order that fuel vapors can be condensed in said gas container. In one alternative embodiment, the gas container can also be omitted almost completely and can be configured as a pure Y-branch.

The fuel vapor can also be a fuel-containing vapor which has a mixture of fuel vapor and air. Fuel vapors which are first of all fed to the gas container can escape in the fuel tank, for example, on account of temperature changes or as a result of a filling operation. From said gas container, the fuel vapors are fed, for example, preferably to the second line which is connected to a fuel supply of the internal combustion engine. The fuel vapors can optionally be condensed in the gas container or else in the second line. As a result of being pumped into the fuel system of the internal combustion engine (pressure level, for example, 4 bar), the vapors are compressed and are partially condensed directly.

If, for example, this type of tank venting is not sufficient, the pressure rises in the gas container, with the result that the pressure holding valve finally opens an access to the first line. Said first line can be connected via an activated charcoal filter to the air supply path of the internal combustion engine. Here, the air supply path can have, for example, an intake manifold and a turbocharger. The fuel vapors are initially stored in the activated charcoal filter in the first line and the air can escape into the surroundings through a fresh air opening of the activated charcoal filter. In the case of an internal combustion engine which is running, the activated charcoal filter can be regenerated by a generation of a vacuum in the intake manifold, by fresh air being sucked through the fresh air opening of the activated charcoal filter into the second line and into the air supply path.

According to one exemplary embodiment of the invention, a fuel vapor condenser is arranged in the second line. The fuel vapor condenser has a pump, in particular a compression pump, and/or a cooling unit.

The pump can be configured to compress the fuel vapors and to condense them. Here, the fuel vapors can be compressed to the pressure level of the fuel supply system. This can be, for example, the system pressure in the case of manifold injection. In the case of gasoline direct injection (GDI), this can be the pressure in the low pressure system. The fuel liquefying or condensation can be assisted, for example, by way of additional cooling, for example, by means of a coolant which is flushed around the second line. As an alternative or in addition, a cooling unit can be arranged upstream or downstream of the pump.

According to a further exemplary embodiment of the invention, the system has a bubble separator which is arranged downstream of the fuel vapor condenser, in particular downstream of the pump. For example, the bubble separator can be arranged between the fuel vapor condenser and the internal combustion engine. The bubble separator separates gases and/or air from the condensed fuel vapor and guides them via a venting line to the gas container or the second line upstream of the fuel vapor condenser.

It cannot be ensured that the fuel vapors are condensed completely during compression of said fuel vapors. The compressed gas can certainly still contain gases, in particular air, which cannot be condensed. Said gases have to be separated, since they must not pass to the injection valves.

The bubble separator (also called vapor bubble separator or air bubble separator) prevents gases passing to the internal combustion engine, in particular to the injection system. The bubble separator can be configured, for example, as a container on a fuel line. Air bubbles can be caught and rise to the surface in the bubble separator. The bubble separator contains, for example, a float. If the gas bubble which is produced becomes too large on the ceiling of the bubble separator, the float sinks and opens a valve on account of the gravity which acts on it or on account of its weight (counter to a fuel system pressure), with the result that the gas can escape in the direction of the gas container. The separated vapor can then be introduced, for example, into the gas container or the secondline, in order that it is not output to the environment.

The fuel condenser, in particular the pump, as a rule runs merely in the case of an internal combustion engine which is running According to one exemplary embodiment of the invention, condensation is also possible in the case of an internal combustion engine which is at a standstill. To this end, a fuel pump which is arranged in the fuel supply path has a non-return valve, with the result that no fuel can flow back into the fuel tank in the case of an engine which is at a standstill. Furthermore, a buffer volume is provided in the bubble separator, with the result that the fuel which is condensed in the second line in the case of an engine which is at a standstill can collect there.

According to a further exemplary embodiment of the invention, a filter, in particular an activated charcoal filter, is provided in the first line. The activated charcoal filter is configured to receive fuel vapor and has a fresh air opening. The regeneration of the activated charcoal filter in the case of an internal combustion engine which is running can take place with a low priority, for example, by an actuation of a tank venting valve by way of a control unit.

According to a further exemplary embodiment of the invention, a pressure holding valve is arranged on the first line between the gas container and the activated charcoal filter. If a defined differential pressure value between the gas container and the activated charcoal filter is exceeded, the pressure holding valve can open both in one direction and in the other direction. If the difference of the pressures lies below a defined threshold value, the pressure holding valve remains closed in both directions. If a first pressure in the gas container is greater by a predefined first threshold value than a second pressure in the activated charcoal filter, the pressure holding valve opens in the direction of the activated charcoal filter. If the first pressure in the gas container is smaller by a predefined second threshold value than the second pressure in the activated charcoal filter, the pressure holding valve opens in the direction of the gas container, with the result that, for example, a vacuum in the gas container or in the fuel tank can be equalized by sucking in the fresh air through a fresh air opening of the activated charcoal filter. The magnitude of the first threshold value can correspond to the magnitude of the second threshold value. As an alternative, the magnitudes of the first and second threshold values can be different. The pressure holding valve can have, for example, two parallel lines with non-return valves which are oriented in opposite directions.

According to a further exemplary embodiment of the invention, a pressure sensor is arranged in the gas container, which pressure sensor is configured to determine a current pressure and to transmit it to a control unit. Here, the control unit is connected functionally to the pressure sensor and to the fuel vapor condenser. As soon as the current pressure in the gas container has reached a predefined pressure setpoint value, the control unit activates the pump or a pump motor, with the result that fuel vapor condensing takes place in the second line and the pressure does not rise further and therefore the pressure holding valve does not have to open.

According to a further exemplary embodiment of the invention, a tank venting valve is arranged in the first line between the filter and the internal combustion engine and is connected functionally to the control unit. The control unit is configured to open the tank venting valve merely in the case of an internal combustion engine which is running, with the result that the activated charcoal filter is regenerated by fresh air being sucked into the intake manifold.

According to a second aspect of the invention, a motor vehicle is proposed having a fuel tank, an internal combustion engine with an air supply path and a fuel supply path and a system which is described above for venting the fuel tank.

### BRIEF DESCRIPTION OF THE DRAWINGS

Further features and advantages of the present invention are apparent to a person skilled in the art from the following description of exemplary embodiments which are not, however, to be interpreted as restricting the invention, with reference to the appended drawing, in which:

FIG. 1 shows a cross section through a system for venting a fuel tank.

### DETAILED DESCRIPTION

The FIGURE is merely a diagrammatic illustration of the apparatus according to the invention or its constituent parts according to exemplary embodiments of the invention. In particular, distances and size relations are not reproduced in the FIGURE in a manner which is true to scale.

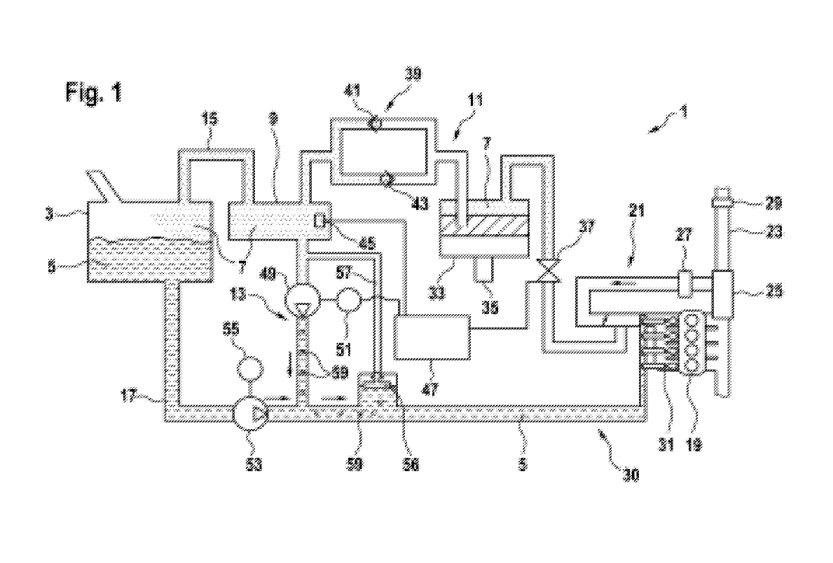

FIG. 1 shows the system 1 for venting a fuel tank 3. The system 1 can be called a tank venting system. In the exemplary embodiment which is shown, fuel 5 is situated in the lower part of the fuel tank 3 and fuel vapor 7 is situated in the upper part of the fuel tank 3. A fuel line 17 is provided in the lower region of the fuel tank, which fuel line 17 connects the fuel tank 3 to the fuel supply path 30 of the internal combustion engine 19. Fuel 5 is pumped from the fuel tank 3 to the injection system 31 of the internal combustion engine 19 by means of a fuel pump 53 which is provided in the fuel line 17. The fuel pump 53 can be driven by a fuel pump motor 55, in particular by an electric motor.

As has already been mentioned above, the internal combustion engine 19 is supplied with fuel 5 via a fuel supply path 30 with an injection system 31. Furthermore, the internal combustion engine 19 is supplied with air via an air supply path 21. The air supply path 21 has an intake manifold 23, in which a vacuum can be generated and air can be sucked in. Furthermore, a turbocharger 25 for compressing the air can be provided in the air supply path 21. Furthermore, the air supply path 21 can have a charge air cooler 27 and an air flow meter (AFM) 29. A possible second entry point of the tank venting into the air path upstream of the compressor is not shown here for the sake of simplicity.

The system 1 for venting the fuel tank 3 has a gas container 9 which is connected via a third line 15 to the fuel tank 3. Here, the third line 15 is configured in such a way that no fuel 5, but rather merely gases, in particular fuel vapor 7, can reach the gas container 9. The gas container 9 is connected via a first line 11 to the air supply path 21 of the internal combustion engine 19 and via a second line 13 to the fuel supply path 30 of the internal combustion engine 19. The gas container 9 can have a cooling means, with the result that fuel vapors are already condensed in said gas container 9. In an alternative embodiment (not shown in the FIGURE), the gas container 9 can be configured as a pure Y-branch or T-branch consisting of a first line 11, second line 13 and third line 15.

The fuel vapor 7 initially collects in the gas container 9. Here, a pressure sensor 45 is provided in the gas container 9, which pressure sensor 45 determines the current pressure in the gas container 9 and transmits it to a control unit 47. As soon as the pressure in the gas container 9 exceeds a pressure setpoint value and if the internal combustion engine 19 is currently running, the control unit 47 activates a fuel vapor condenser 49. The fuel vapor condenser 49 is arranged in the second line 13 and is configured as a compression pump with a motor 51. Here, the control unit 47 can activate the motor 51 of the fuel vapor condenser 49 directly, for example. Furthermore, the fuel vapor condenser 49 can have a cooling unit. As a result of the compressing and optional cooling in the fuel vapor condenser 49, the fuel vapor 7 becomes liquid and can be fed via the second line 13 to the fuel line 17 and therefore to the fuel supply path 30.

Furthermore, non-condensed gases, such as air, can be contained in the condensed fuel in the second line 13. Said gases must not pass to the injection system 31. A bubble separator 56 is therefore provided in the fuel line 5 between the internal combustion engine 19 and the fuel vapor condenser 49. In one exemplary embodiment (not shown), the bubble separator 56 can be arranged upstream of the fuel vapor condenser 49 on the second line 13. The bubble separator 56 is configured as a container with a float, in which container gas bubbles 59 are separated from the fuel. The more gases or gas bubbles 59 are situated above the liquid fuel in the bubble separator 56, the lower the fuel level in the bubble separator 56 and the lower the buoyancy of the float. If the filling level undershoots a defined level, the float drops downward and the valve to a venting line 57 is opened. The venting line 57 connects the bubble separator 56 to the second line 13 upstream of the fuel vapor condenser 49. Furthermore, the venting line 57 can feed the gases from the fuel to the gas container 9 (not shown in FIG. 1).

A filter, in particular an activated charcoal filter 33, is provided in the first line 11. A pressure holding valve 39 is provided between the activated charcoal filter 33 and the gas container 9. The pressure holding valve 39 can open automatically if a defined differential pressure between gas container 9 and activated charcoal filter 33 is exceeded. Here, the pressure holding valve 39 can have two parallel lines. A first non-return valve 41 is arranged in one line. A second non-return valve 43 which is oriented in the opposite direction to the first non-return valve 41 is provided in the other line. Both non-return valves open in the forward direction in each case only above a certain differential pressure (tank pressure holding function).

The connection to the air supply path 21 via the first line 11 can be advantageous, in particular, in the case of an internal combustion engine 19 which is at a standstill. The fuel line 17 and the fuel pump 53 can be inactive in the case of an internal combustion engine 19 which is at a standstill, with the result that condensing of fuel vapors 7 in the second line 13 by the fuel vapor condenser 49 also does not take place. An impermissible positive pressure as a result of fuel vapors 7 in the fuel tank 3 and in the gas container 9 can be produced by pronounced incident solar radiation or the vehicle being switched off in the hot state. An impermissible vacuum in the fuel tank 3 and also in the container 9 can also be produced by cooling. In this case, the pressure holding valve 39 in the first line 11 can open in one or in the other direction and can make pressure equalization between the surroundings and the fuel tank 3 possible.

In the case of overheating or else in the case of a filling operation, a positive pressure can be produced in the fuel tank 3. If the pressure in the fuel tank 3 or the pressure in the gas container 9 exceeds the pressure at the activated charcoal filter 33 by a certain predefined threshold value, the pressure holding valve 39 opens in the direction of the activated charcoal filter 33. Here, for example, the first non-return valve 41 can be released or opened. After opening of the pressure holding valve 39 in the direction of the activated charcoal filter 33, a mixture of fuel vapor 7 and air flows into the activated charcoal filter 33. The air can escape through a fresh air opening 35 in the activated charcoal filter 33, whereas hydrocarbons are stored in the activated charcoal filter 33. In this way, pressure equalization takes place. As soon as the internal combustion engine 19 is running again, the activated charcoal filter 33 can be regenerated again by sucking fresh air in through the fresh air opening 35 in the direction of the intake manifold 23. The regeneration of the activated charcoal filter 33 can be regulated via a tank venting valve 37 which is arranged in the first line 11 between the activated charcoal filter 33 and the intake manifold 23. Here, the tank venting valve 37 can be actuated by the control unit 47.

In the case of a vacuum in the fuel tank 3 or in the gas container 9, the pressure holding valve 39 can be opened in the direction of the gas container 9. This can take place, for example, by release or opening of the second non-return valve 43. After the opening of the pressure holding valve 39, fresh air flows through the fresh air opening 35 of the activated charcoal filter 33 and a pressure equalization between the surroundings and fuel tank 3 or gas container 9 takes place.

In an alternative exemplary embodiment which is not shown in FIG. 1, condensing of fuel vapors 7 can take place in the second line 13 even in the case of an internal combustion engine 19 which is at a standstill. Here, a non-return valve is provided in the fuel pump 53 and the bubble separator 56 has a buffer volume for receiving the condensed fuel.

Finally, it is noted that expressions such as “having” or the like are not to rule out that further elements or steps can be provided. Furthermore, it is to be noted that “a” or “one” does not rule out a multiplicity. Moreover, features which are described in conjunction with the various embodiments can be combined with one another as desired. Furthermore, it is noted that the reference numerals in the claims are not to be interpreted as restricting the scope of the claims.

1. A system (1) for venting a fuel tank (3), the system (1) having
a gas container (9) which is configured to receive fuel vapor (7) from the fuel tank (3);
a first line (11) which connects the gas container (9) to an air supply path (21) of an internal combustion engine (19); and a second line (13) which connects the gas container (9) to a fuel supply path (30) of the internal combustion engine (19).

2. The system (1) as claimed in claim 1,
a fuel vapor condenser (49) being arranged in the second line (13); and
the fuel vapor condenser (49) being configured to condense the fuel vapor which is situated in the second line (13).

3. The system (1) as claimed in claim 2, having, furthermore,
a bubble separator (56) which is arranged between the fuel vapor condenser (49) and the internal combustion engine (19) and is configured to separate gases from the condensed fuel vapor, wherein a venting line (57) guides separated gases to the gas container (9).

4. The system (1) as claimed in claim 3, having, furthermore,
a fuel pump (53) which is arranged upstream of the second line (13) in the fuel supply path (30), the fuel pump (53) being configured to pump fuel (5) from the fuel tank (3) to the internal combustion engine (19);
the fuel pump (53) having a non-return valve which opens in a direction of the internal combustion engine (19); and
a buffer volume being provided in the bubble separator (56), which buffer volume is configured to receive fuel which is condensed in the second line (13) in the case of an internal combustion engine (19) which is at a standstill and a fuel vapor condenser (49) which is running.

5. The system (1) as claimed in claim 2,
the fuel vapor condenser (49) having at least one of a pump and a cooling unit,
the cooling unit being arranged upstream and/or downstream of the pump.

6. The system (1) as claimed in claim 1,
a filter (33) being provided in the first line (11);
the filter (33) being configured to receive fuel vapor (7).

7. The system (1) as claimed in claim 6, the filter (33) having a fresh air opening (35).

8. The system (1) as claimed in claim 6,
a pressure holding valve (39) being arranged in the first line (11) between the gas container (9) and the filter (33);
the pressure holding valve (39) being configured to allow fuel vapor to pass from the gas container (9) to the filter (33) if a first pressure in the gas container (9) exceeds a second pressure in the filter (33) by a predefinable threshold value; and
the pressure holding valve (39) being configured to allow fuel vapor to pass from the filter (33) to the gas container (9) if the second pressure in the filter (33) exceeds the first pressure in the gas container (9) by a predefinable threshold value.

9. The system (1) as claimed in claim 2, having, furthermore,
a pressure sensor (45) which is arranged on the gas container (9) and is configured to determine a current pressure in the gas container (9); and
a control unit (47) which is connected functionally in each case to the pressure sensor (45) and to the fuel vapor condenser (49);
the control unit (47) being configured to receive the current pressure from the pressure sensor (45) and, if said current pressure exceeds a predefinable pressure setpoint value, to activate the fuel vapor condenser (49).

10. The system (1) as claimed in claim 9, having, furthermore,
a tank venting valve (37) which is arranged in the first line (11) between the filter (33) and the internal combustion engine (19);
the control unit (47) being connected functionally to the tank venting valve (37); and
the control unit (47) being configured to open the tank venting valve (37) in the case of an internal combustion engine (19) which is running.

11. A motor vehicle comprising:
a fuel tank (3);
an internal combustion engine (19) having an air supply path (21) and a fuel supply path (30); and
a system (1) for venting the fuel tank (3), the system (1) having a gas container (9) which is configured to receive fuel vapor (7) from the fuel tank (3), a first line (11) which connects the gas container (9) to the air supply path (21) of the internal combustion engine (19), and a second line (13) which connects the gas container (9) to the fuel supply path (30) of the internal combustion engine (19).

12. The motor vehicle as claimed in claim 11,
a fuel vapor condenser (49) being arranged in the second line (13); and
the fuel vapor condenser (49) being configured to condense the fuel vapor which is situated in the second line (13).

13. The motor vehicle as claimed in claim 12, having, furthermore,
a bubble separator (56) which is arranged between the fuel vapor condenser (49) and the internal combustion engine (19) and is configured to separate gases from the condensed fuel vapor, wherein a venting line (57) guides separated gases to the gas container (9).

14. The motor vehicle as claimed in claim 13, having, furthermore,
a fuel pump (53) which is arranged upstream of the second line (13) in the fuel supply path (30), the fuel pump (53) being configured to pump fuel (5) from the fuel tank (3) to the internal combustion engine (19);
the fuel pump (53) having a non-return valve which opens in a direction of the internal combustion engine (19); and
a buffer volume being provided in the bubble separator (56), which buffer volume is configured to receive fuel which is condensed in the second line (13) in the case of an internal combustion engine (19) which is at a standstill and a fuel vapor condenser (49) which is running.

15. The motor vehicle as claimed in claim 12,
the fuel vapor condenser (49) having at least one of a pump and a cooling unit,
the cooling unit being arranged upstream and/or downstream of the pump.

16. The motor vehicle as claimed in claim 11,
a filter (33) being provided in the first line (11);
the filter (33) being configured to receive fuel vapor (7).

17. The motor vehicle as claimed in claim 16, the filter (33) having a fresh air opening (35).

18. The motor vehicle as claimed in claim 16,
a pressure holding valve (39) being arranged in the first line (11) between the gas container (9) and the filter (33);
the pressure holding valve (39) being configured to allow fuel vapor to pass from the gas container (9) to the filter (33) if a first pressure in the gas container (9) exceeds a second pressure in the filter (33) by a predefinable threshold value; and
the pressure holding valve (39) being configured to allow fuel vapor to pass from the filter (33) to the gas container (9) if the second pressure in the filter (33) exceeds the first pressure in the gas container (9) by a predefinable threshold value.

19. The motor vehicle as claimed in claim 12, having, furthermore,
a pressure sensor (45) which is arranged on the gas container (9) and is configured to determine a current pressure in the gas container (9); and
a control unit (47) which is connected functionally in each case to the pressure sensor (45) and to the fuel vapor condenser (49);
the control unit (47) being configured to receive the current pressure from the pressure sensor (45) and, if said current pressure exceeds a predefinable pressure setpoint value, to activate the fuel vapor condenser (49).

20. The motor vehicle as claimed in claim 19, having, furthermore,
a tank venting valve (37) which is arranged in the first line (11) between the filter (33) and the internal combustion engine (19);
the control unit (47) being connected functionally to the tank venting valve (37); and
the control unit (47) being configured to open the tank venting valve (37) in the case of an internal combustion engine (19) which is running.
